(19) United States
(12) Patent Application Publication
(10) Pub. No.: US 2025/0319898 A1
(43) Pub. Date: Oct. 16, 2025

(54) ACTION CONTAMINATION ATTACK SYSTEM FOR AUTONOMOUS DRIVING MODEL AND ACTION CONTAMINATION ATTACK METHOD OF THE SAME

(71) Applicant: Foundation of Soongsil University-Industry Cooperation, Seoul (KR)

(72) Inventors: Daeseon CHOI, Daejeon (KR); Yoonsoo AN, Seoul (KR)

(21) Appl. No.: 19/250,845

(22) Filed: Jun. 26, 2025

Related U.S. Application Data
(63) Continuation of application No. PCT/KR2024/006069, filed on May 7, 2024.

(30) Foreign Application Priority Data
Nov. 14, 2023 (KR) 10-2023-0157018

(51) Int. Cl. B60W 60/00; B60W 50/06

(52) U.S. Cl. CPC B60W 60/0011; B60W 50/06; B60W 2520/00

(57) ABSTRACT

An action poisoning attack system for an autonomous driving model trained based on an action of each agent determining a movement of each of the agents driving virtually in a virtual space may include a target agent determination unit configured to determine a target agent that is an attack target intended to perform virtual driving by manipulated action information instead of action information output by the autonomous driving model among a plurality of the agents, based on position information of the agents in the virtual space, and a target action determination unit configured to interfere with training of the autonomous driving model by generating target action information by manipulating the action information output by the autonomous driving model for the target agent and causing the target agent to perform a target action that is an action by the target action information.

### TECHNICAL FIELD

The present invention relates to an action poisoning attack system for an autonomous driving model trained based on an action of each agent determining a movement of each of the agents driving virtually in a virtual space.

The present invention is derived from research conducted as part of the Ministry of Science and ICT's Blockchain Technology Development for Data Economy (Project Identification No.: 1711194405, Project No.: 2021-0-00565-003, Research Project Title: Development of User Identity Authentication and Management Technology for Utilizing Self-Sovereign Identity, Project Management Institute: Institute of Information & Communications Technology Planning & Evaluation, Project Executing Institute: Comin Information Systems Inc., Research Period: Jan. 1, 2023 to Dec. 31, 2023) and the Defense Acquisition Program Administration's Leading Technology Development (Project No.: KRIT-CT-21-037, Research Project Title: Cyber Battlefield Management Artificial Intelligence Model Security Technology, Project Management Institute: Korea Research Institute for Defense Technology Planning and Advancement, Project Executing Institute: Soongsil University Foundation of University-Industry Cooperation, Research Period: Dec. 24, 2021 to Dec. 23, 2026). Meanwhile, the Korean government has no profit in property in any aspect of the present invention.

### BACKGROUND

A representative security vulnerability of deep reinforcement learning models is a poisoning attack. The poisoning attack on the deep reinforcement learning models may also be applied to a multi-agent reinforcement learning model. Accordingly, research of the poisoning attack on the multi-agent reinforcement learning model is actively being conducted.

In a case of the reinforcement learning model, there is a possibility of being exposed to attacks that contaminate one or more of observation as input of the model, action as output of the model, and reward as involved in policy training of the model. Since conventional techniques focus on observation or reward poisoning attacks, there is a lack of consideration of a risk of action poisoning attacks in which training of remaining agents is disturbed by contaminated actions of other agents in the multi-agent reinforcement learning model.

### SUMMARY

### Technical Problem

The present invention is directed to providing an action poisoning attack system capable of evaluating safety of an autonomous driving model based on multi-agent deep reinforcement learning through a locality-based action poisoning attack, and a method of controlling the action poisoning attack system.

In addition, the present invention is directed to providing of the action poisoning attack system which allows an attacker to perform an appropriate attack even in a situation in which the attacker only has a black box access right to the autonomous driving model based on multi-agent reinforcement learning having a continuous action space, and the method of controlling the action poisoning attack system.

In addition, the present invention is directed to providing the action poisoning attack system capable of interfering with training of the autonomous driving model (victim model) through a target action and causing convergence to a suboptimal policy, and the method of controlling the action poisoning attack system.

In addition, the present invention is directed to providing of the action poisoning attack system in which a developer of the autonomous driving model may test the safety of the autonomous driving model while testing action manipulation attacks in a training step and can prepare a defense technique against the attacks, and the method of controlling the action poisoning attack system.

### Technical Solution

An action poisoning attack system for an autonomous driving model trained based on an action of each agent determining a movement of each of the agents driving virtually in a virtual space according to an aspect of the disclosed invention may include: a target agent determination unit configured to determine a target agent that is an attack target intended to perform virtual driving by manipulated action information instead of action information output by the autonomous driving model among a plurality of the agents, based on position information of the agents in the virtual space; and a target action determination unit configured to interfere with training of the autonomous driving model by generating target action information by manipulating the action information output by the autonomous driving model for the target agent and causing the target agent to perform a target action that is an action by the target action information, wherein the autonomous driving model is a machine learning model trained through a machine learning method based on the actions of the agents while determining the action information of each agent based on positions and actions of the other agents in the virtual space.

In addition, the autonomous driving model may be configured to generate an action vector including a steering component related to steering of each of the agents and an acceleration component related to acceleration/deceleration of each of the agents as the action information for each of the agents, and the target action determination unit may be configured to generate a target action vector including a manipulation steering component and a manipulation acceleration component by changing at least one of the steering component and the acceleration component of the action vector output by the autonomous driving model.

In addition, the target action determination unit may be configured to: generate the target action vector including the manipulation steering component with an intention of driving virtually in a direction completely opposite to a direction in which the target agent has steered based on an action by the action vector output by the autonomous driving model; and generate the target action vector including the manipulation acceleration component with an intention of driving virtually in the direction completely opposite to the direction at speed at which the target agent has accelerated/decelerated based on the action by the action vector output by the autonomous driving model.

In addition, the target agent determination unit may be configured to: determine a number of proximity agents that are other agents positioned within a preset reference distance for each of the agents based on each of the agents; and determine an agent of which the number of the proximity agents is greater than or equal to a preset number as the target agent among the plurality of agents.

In addition, the target action determination unit may be configured to: determine an average value of the steering components of the action vector output by the autonomous driving model for the proximity agents as an average steering component; determine an average value of the acceleration components of the action vector output by the autonomous driving model for the proximity agents as an average acceleration component; generate the target action vector including the manipulation steering component with an intention of driving virtually in a direction completely opposite to a direction in which the target agent has steered based on an action of the action vector including the average steering component; and generate the target action vector including the manipulation acceleration component with an intention of driving virtually in the direction completely opposite to the direction at speed at which the target agent has accelerated/decelerated based on an action of the action vector including the average acceleration component.

In addition, the target action determination unit may be configured to: determine a weighted average value of speeds of the proximity agents driving virtually based on the action by the action vector output by the autonomous driving model as a weighted average speed; determine a similarity between a speed of the target agent driving virtually based on the action by the action vector output by the autonomous driving model and the weighted average speed; and determine the manipulation acceleration component based on the similarity between the speed of the target agent and the weighted average speed.

In addition, the target action determination unit may be configured to determine the manipulation acceleration component with an intention of driving virtually while accelerating more significantly as the similarity between the speed of the target agent and the weighted average speed is lower.

In addition, the target action determination unit may be configured to determine the manipulation steering component with an intention of driving virtually while changing a direction of the virtual driving more significantly as the similarity between the speed of the target agent and the weighted average speed is higher.

In addition, the target action determination unit may be configured to: determine one real number randomly selected from preset real numbers as the manipulation steering component; and determine one real number randomly selected from the preset real numbers as the manipulation steering component.

A method of controlling the action poisoning attack system for an autonomous driving model trained based on an action of each agent determining a movement of each of the agents driving virtually in a virtual space may include: determining, by a target agent determination unit, a target agent that is an attack target intended to perform virtual driving by manipulated action information instead of action information output by the autonomous driving model among a plurality of the agents, based on position information of the agents in the virtual space; generating, by a target action determination unit, target action information by manipulating the action information output by the autonomous driving model for the target agent; and interfering, by the target action determination unit, with training of the autonomous driving model by causing the target agent to perform a target action that is an action by the target action information, wherein the autonomous driving model may be a machine learning model configured to be trained through a machine learning method based on the actions of the agents while determining the action information of each agent based on positions and actions of the other agents in the virtual space, and generate an action vector including a steering component related to steering of each of the agents and an acceleration component related to acceleration/deceleration of each of the agents as the action information for each of the agents, the determining of the target agent may include: determining a number of proximity agents that are other agents positioned within a preset reference distance for each of the agents based on each of the agents by the target agent determination unit; and determining an agent of which the number of the proximity agents is greater than or equal to a preset number as the target agent among the plurality of the agents by the target agent determination unit, and the generating of the target action information may include generating a target action vector including a manipulation steering component and a manipulation acceleration component as target action information for the target agent by changing at least one of the steering component and the acceleration component of the action vector output by the autonomous driving model by the target action determination unit.

A computer-readable non-transitory recording medium may be configured to store a computer-readable program so as to execute a method of controlling an action poisoning attack system for an autonomous driving model trained based on an action of each agent determining a movement of each of the agents driving virtually in a virtual space.

### Advantageous Effects

According to an aspect of the disclosed invention, safety of an autonomous driving model based on multi-agent deep reinforcement learning can be evaluated through a locality-based action poisoning attack.

In addition, according to an embodiment of the present invention, an attacker can perform an appropriate attack even in a situation in which the attacker only has a black box access right to an autonomous driving model based on multi-agent reinforcement learning having a continuous action space.

In addition, according to an embodiment of the present invention, it is possible to interfere with training of the autonomous driving model (victim model) through a target action and cause convergence to a suboptimal policy.

In addition, according to an embodiment of the present invention, a developer of the autonomous driving model can test the safety of the autonomous driving model while testing action manipulation attacks in a training step and prepare a defense technique against the attacks.

### BRIEF DESCRIPTION OF THE DRAWINGS

FIG. 1 is a configuration diagram of an action poisoning attack system according to an embodiment.

FIG. 2 is a diagram describing a method of performing an action poisoning attack for a target agent according to an embodiment.

FIG. 3 is a diagram describing a method of generating an action vector for the target agent according to an embodiment.

FIG. 4 is a flowchart of an action poisoning attack method according to an embodiment.

FIG. 5 is a diagram describing an experiment to verify an action poisoning attack method in an intersection map according to an embodiment.

FIG. 6 is a diagram describing an experiment to verify an action poisoning attack method in a roundabout map according to an embodiment.

FIG. 7 is a diagram describing an experiment to verify an action poisoning attack method in a bottleneck road map according to an embodiment.

FIG. 8 is a graph for describing a performance of the action poisoning attack method in the intersection map according to an embodiment.

FIG. 9 is a graph for describing a performance of the action poisoning attack method in the roundabout map according to an embodiment.

FIG. 10 is a graph for describing a performance of the action poisoning attack method in a bottleneck road map according to an embodiment.

FIG. 11 is a table for describing a performance of the action poisoning attack method according to an embodiment.

### DETAILED DESCRIPTIONS OF EXEMPLARY EMBODIMENTS

Like reference numerals refer to like elements throughout. The present specification does not describe all elements of the embodiments, and general contents in the art to which the disclosed invention belongs or contents that are redundant between the embodiments are omitted. The term ‘unit’ used in this specification may be implemented as software or hardware, and according to embodiments, a plurality of ‘units’ may be implemented as one element, or one ‘unit’ may include a plurality of elements.

In addition, when a certain part “includes” a certain component, this does not exclude other components from being included unless described otherwise, and other components may in fact be included.

The term ‘unit’ used in this specification refers to a unit that processes at least one function or operation, and may refer to, for example, software, an FPGA, or a hardware element. The functions provided by the ‘unit’ may be performed separately by a plurality of elements, or may be integrated with other additional elements. The ‘unit’ of this specification is not necessarily limited to software or hardware, and may be configured to be in a recording medium that can be addressed, and may be configured to reproduce one or more processors.

A singular expression includes a plural expression, unless otherwise implied clearly in the context.

In each step, reference numerals are used for convenience of description and do not describe the order of each step. Each step may be performed differently from the specified order unless a specific order is clearly described in the context.

Hereinafter, a working principle and the embodiments of the disclosed invention will be described with reference to the following drawings.

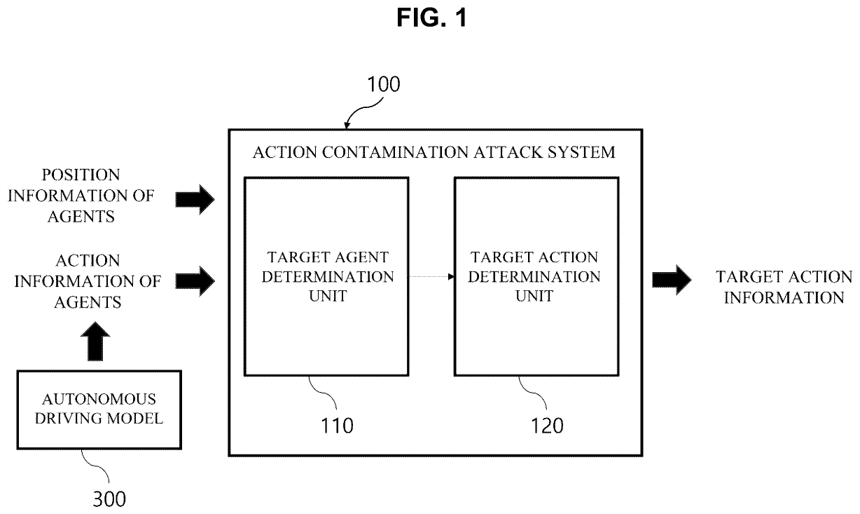

FIG. 1 is a configuration diagram of an attack detection system according to an embodiment.

Referring to FIG. 1, an action poisoning attack system 100 according to an embodiment of the present invention may include a target agent determination unit 110 and a target action determination unit 120. The action poisoning attack system 100 may be provided on an attacker's terminal or server, but a position of the action poisoning attack system 100 is not limited thereto.

The action poisoning attack system 100 may interfere with training of an autonomous driving model 300, which is trained based on an agent 200 driving virtually in a virtual space. Each of the agents 200 may be an object representing a virtual vehicle driving in a virtual space where a road is represented. However, the object represented by the agent 200 is not necessarily limited to a vehicle.

Machine learning may refer to using a model consisting of a plurality of parameters and optimizing the parameters with given data. The machine learning may include supervised learning, unsupervised learning, and reinforcement learning depending on a form of a learning question. The supervised learning is a process of learning a mapping between an input and an output and may be applied when a pair of the input and the output is given as a data. The unsupervised learning is applied when there is only the input and no output and may find a regularity between the inputs.

The autonomous driving model 300 may be a machine learning model trained based on an action of each agent 200 that determines a movement of each of the agents 200 driving virtually in the virtual space. Specifically, the autonomous driving model 300 may be the machine learning model that is trained by a deep reinforcement learning method based on the action of the agent 200 while determining an action information of each agent 200 based on the positions and actions of the other agents 200 in the virtual space.

Deep reinforcement learning used in training of the autonomous driving model 300 may be an unsupervised learning model for training a policy which is a behavior of the agents 200, while interacting with a defined environment. In this case, each agent 200 may take an action appropriate for observations obtained from the environment, receive a reward for that action, and select a next action. The autonomous driving model 300 may be the unsupervised learning model of which policy is trained to maximize an expected value of the reward that may be obtained using observation, action, and reward data obtained through an interaction with the agent 200.

A learning method of the autonomous driving model 300 may be Multi-Agent Reinforcement Learning (MARL). This may be a learning method of training a plurality of the agents 200 to interact with the environment so as to perform a target task. This may be applied to a swarm robot, a drone, and an autonomous driving technology, and in particular, may be used for learning in which security is important, such as controlling a swarm agent 200. For example, the learning method of the autonomous driving model 300 may be a MARL method that is characterized by importance of the interaction between the agents 200 and instability of convergence, such as applying a Partially Observable Markov Decision Process (POMDP) that considers a possibility of partial observation in which each agent 200 may observe only a certain distance nearby and all the agents 200 may not know the entire situation.

The action information may include information about acceleration, deceleration, and steering that serve as a basis for determining the movement of the agent 200 driving virtually in the virtual space. Each of the agents 200 may drive in the virtual space based on data of action information at every moment. The data of such action information may have different values at every moment.

The action poisoning attack system 100 may interfere with the training of the autonomous driving model 300 by performing action contamination in a method of manipulating the action information that determines the movement of the agent 200 with respect to the autonomous driving model 300.

An attack method of the action poisoning attack system 100 may be an action poisoning attack. The action poisoning attack may be an attack method in which an attacker between the environment and the agent 200 manipulates the action of the agent 200 being trained to interfere with the training of the policy, thereby inducing a convergence to a suboptimal policy. The action poisoning attack method may also be applied to a multi-agent reinforcement learning model. Since multi-agent reinforcement learning has a plurality of the agents 200 sharing the same environment, when the attacker manipulates the action information of some agents 200, observation values of the other agents 200 may also be disturbed, and at the same time, may interfere with convergence to an optimal policy.

The target agent determination unit 110 may receive position information of the agents 200 and action information of the agents 200 generated by the autonomous driving model 300.

The target agent determination unit 110 may determine a target agent 201 that is an attack target intended to perform virtual driving by manipulated action information instead of the action information output by the autonomous driving model 300 among the plurality of the agents 200, based on the position information of the agents 200 in the virtual space. The target agent determination unit 110 may transfer information of the target agent 201 to the target action determination unit 120.

The target agent determination unit 110 may generate target action information by manipulating the action information output by the autonomous driving model 300 for the target agent 201. The target agent determination unit 110 may interfere with training of the autonomous driving model 300 by causing the target agent 201 to perform a target action that is an action by the target action information.

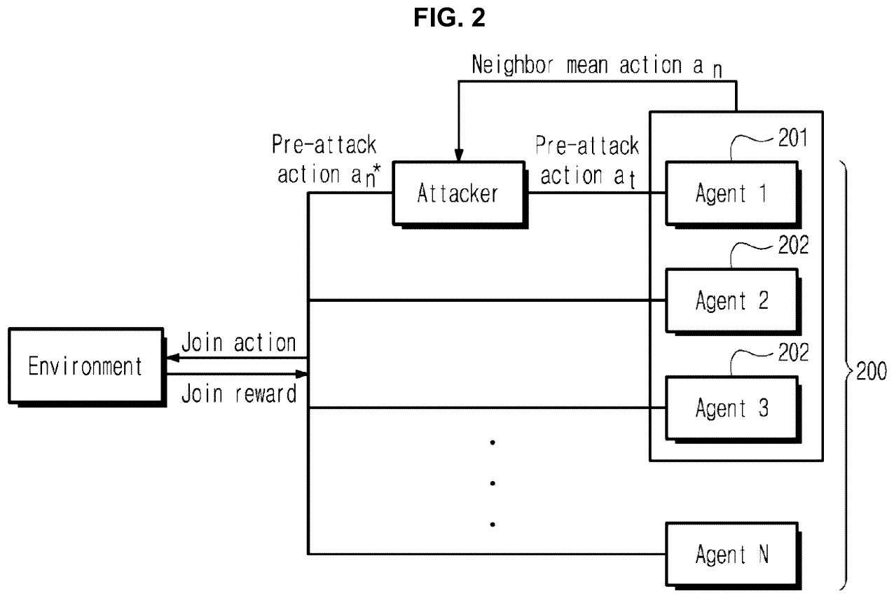

FIG. 2 is a diagram describing a method of performing an action poisoning attack for a target agent according to an embodiment.

Referring to FIG. 2, a process of the action poisoning attack in a multi-agent reinforcement learning environment may be confirmed. In this case, since the proposed action poisoning attack in the multi-agent reinforcement learning environment may not manipulate observation of the agent 200 and reward functions, it may be assumed that there is an attacker having only more limited black box access rights.

The action poisoning attack system 100 may manipulate an action of one of several target agents 201 as an authority of the attacker. In this case, an access to the black box may be possible in order to request only the action information of a proximity agent 202, which is a neighboring agent 200 during the observation of the target agent 201. In this case, under a specific condition, the attacker may manipulate the action (aᵢ) of the target agent 201 into a contaminated target action (a*ᵢ). For example, it may be a method of performing an attack when a number of neighboring proximity agents 202 within a preset light detection and ranging (LiDAR) radius is 4 or more, but the number of the proximity agents 202 that serves as a reference is not limited thereto. By such an attack, the proximity agent 202 may be disturbed by the action and reward of the target agent 201, and a policy being trained may be interfered from being trained with the optimal policy.

When the action of the agent 200 is discrete, the attacker may manipulate the agent 200 to select a suboptimal action. However, when the action of the agent 200 is in a continuous space like the autonomous driving model 300, there is a problem that it is difficult to determine an appropriate target action. The action poisoning attack system 100 may provide various target actions that the attacker may select in the action poisoning attack for evaluating safety of the autonomous driving model based on the multi-agent reinforcement learning. From a perspective of the attacker, since the attacker selects the target action while having the access to the black box, the attacker should determine an action that seems to be able to interfere with stable driving of the autonomous driving model even without prior information as the target action.

The action poisoning attack system 100 may provide a target action that violates the three principles of Reynolds' flocking algorithm which simulates flocking flight of birds. The three principles described in the Reynolds' flocking algorithm are the principles of cohesion, separation, and alignment, respectively, and may be a theory that individuals within a swarm may safely form a group by keeping a sufficiently narrow distance from other individuals but a sufficient safe distance so as not to collide with them and moving at a similar speed to adjacent individuals.

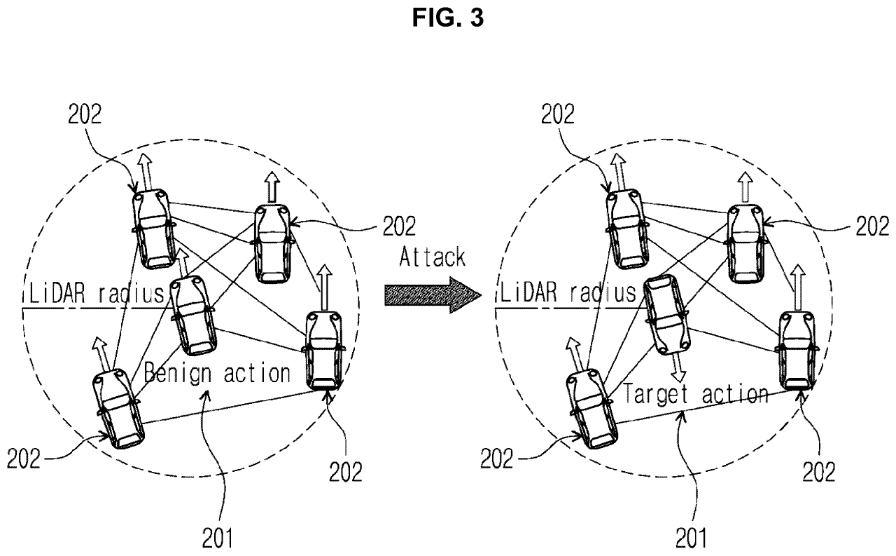

FIG. 3 is a diagram describing a method of generating an action vector for a target agent according to an embodiment.

Referring to FIGS. 1, 2, and 3, the target agent determination unit 110 may determine a number of the proximity agents 202 which are other agents 200 positioned within a preset reference distance for each of the agents 200 based on each of the agents 200. The reference distance may be a distance in the virtual space corresponding to a distance at which nearby vehicles may be detected from a perspective of an actual LiDAR sensor.

The target agent determination unit 110 may determine the agent 200 of which the number of the proximity agents 202 is greater than or equal to a preset number as the target agent 201 among a plurality of the agents 200.

For example, when the preset number is 4, the target agent determination unit 110 may determine the agent 200 of which a number of other agent 200 positioned within a radius of the reference distance is 4 as the target agent 201.

The autonomous driving model 300 may be generate the action vector as action information for each of the agents 200. The action vector may be a vector including a steering component related to steering of each of the agents 200 and an acceleration component related to acceleration/deceleration of each of the agents 200. The steering component may be any one real number between −1 and 1. In this case, when the steering component is −1, the agent 200 that is driving virtually based on the action vector including the steering component may perform a direction change by turning a steering wheel or front tires completely to the left, and when the steering component is 1, the agent 200 that is driving virtually based on the action vector including the steering component may perform a direction change by turning the steering wheel or the front tires completely to the right, but is not limited to this method. In addition, when the acceleration component is −1, the agent 200 that is driving virtually based on the action vector including the acceleration component may perform a virtual driving with maximum acceleration in a backward direction, and when the steering component is 1, the agent 200 that is driving virtually based on the action vector including the acceleration component may perform a virtual driving with maximum acceleration in a forward direction, but is not limited to this method.

The target action determination unit 120 may change at least one of the steering component and the acceleration component of the action vector output by the autonomous driving model 300 to generate the target action vector including a manipulation steering component and a manipulation acceleration component as the target action information for the target agent 201. In this case, the target agent 201 may perform a virtual driving of steering or acceleration/deceleration corresponding to a component value of the target action vector.

In this case, a method of generating the manipulation steering component and the manipulation acceleration component for any one target agent 201 may be one of the methods described later.

The target action determination unit 120 may generate the target action vector including the manipulation steering component with an intention of driving virtually in a direction completely opposite to a direction in which the target agent 201 has steered based on an action by the action vector output by the autonomous driving model 300.

The target action determination unit 120 may generate the target action vector including the manipulation acceleration component with an intention of driving virtually in the direction completely opposite to the direction at speed at which the target agent 201 has accelerated/decelerated based on the action by the action vector output by the autonomous driving model 300.

Meanwhile, according to an attack of an Anti-correlated Action method, the target agent 201 selected by the attacker may calculate an average steering and average acceleration of all of the proximity agents 202 detected in the LiDAR sensor, and then use a value obtained by multiplying the average steering and average acceleration by −1, respectively, as the target action. In this case, the target agent 201 (i_{target}) may perform an action that is opposite to an average action of neighboring proximity agents ({i₁, i₂, . . . , i_{N}}). Meanwhile, each action may be a vector (a real number between −1 and 1) consisting of [steeringᵢ, accelerationᵢ] In this case, steering and acceleration, which are actions of all agents 200 may be real numbers between −1 and 1. When the average action of the neighboring agent is expressed as

$$[ \frac{{\sum }_{n = 1}^{N} {steering}_{{i}_{n}}}{N} , \frac{{\sum }_{n = 1}^{N} {accleration}_{{i}_{n}}}{N} ] ,$$

the action of the target agent 201 may be expressed as

$$- 1 \cdot [ \frac{{\sum }_{n = 1}^{N} {steering}_{{i}_{n}}}{N} , \frac{{\sum }_{n = 1}^{N} {accleration}_{{i}_{n}}}{N} ] ,$$

The target action determination unit 120 may determine an average value of the steering components of the action vector output by the autonomous driving model 300 for the proximity agents 202 as an average steering component. The target action determination unit 120 may determine an average value of the acceleration components of the action vector output by the autonomous driving model 300 for the proximity agents 202 as an average acceleration component.

The target action determination unit 120 may generate the target action vector including the manipulation steering component with an intention of driving virtually in the direction completely opposite to the direction in which the target agent 201 has steered based on the action by the action vector including the average steering component. The target action determination unit 120 may generate the target action vector including the manipulation acceleration component having an intention of driving virtually in the direction completely opposite to the direction at the speed at which the target agent 201 has accelerated/decelerated based on the action by the action vector including the average acceleration component.

Meanwhile, according to an attack of a Human-like disruptive Action method, the attack may be performed by reflecting an unstable action of a human driver such as a movement of a driver who suddenly accelerates rapidly or a driver who changes lanes in a hurry. The target agent 201 selected by the attacker may obtain a weighted sum (v_{neighbor}) of an average speed of the neighboring agents detected within the LiDAR sensor, and then calculate a cosine similarity with a speed (v_{target}) of the target agent 201 as shown in [Equation 1] below. In this case, a result value may be a similarity between the speed of the target agent 201 and a weighted average speed of speeds of the proximity agents 202.

$$cos ( θ ) = \frac{{v}_{neighbor} \cdot {v}_{target}}{‖ {v}_{neighbor} ‖ ‖ {v}_{target} ‖} \qquad [ Equation 1 ]$$

Steering and acceleration, which are actions of the target agent 201, may be manipulated by the manipulation steering component and the manipulation acceleration component calculated as in [Equation 2] below.

$${steering}_{target} = α \times cos ( θ ) , {acceleration}_{target} = β \times \frac{1}{1 + \vert cos ( θ ) \vert} \qquad [ Equation 2 ]$$

This may reflect that it is difficult for a machine learning model to interpret and predict the unstable action of the human driver. That is, the target action may be set based on a cosine similarity between the speed (v_{target}) of the target agent 201 (i_{target}) and the weighted average (v_{neighbor}) speed of the speeds of the proximity agents 202 ({i₁, i₂ . . . , i_{N}}).

A situation in which the cosine similarity is low may be a situation in which the target agent 201 accelerates significantly alone unlike the proximity agent 202, such as rapidly accelerating or changing lanes when starting together in a stopped situation. In this case, when the action is manipulated so as to accelerate significantly with respect to the target agent 201 with low cosine similarity, the action may be more certainly contaminated.

Meanwhile, when the action is manipulated to make a direction change significantly with respect to the target agent 201 with low cosine similarity, it may actually perform appropriate driving with respect to nearby vehicles, so when the action is manipulated to make the direction change significantly with respect to the target agent 201 with high cosine similarity, the action may be more certainly contaminated.

The target action determination unit 120 may determine the weighted average value of the speeds of the proximity agents 202 driving virtually based on the action by the action vector output by the autonomous driving model 300 as the weighted average speed. The target action determination unit 120 may determine a similarity between the speed of the target agent 201 driving virtually based on the action by the action vector output by the autonomous driving model 300 and the weighted average speed.

The target action determination unit 120 may determine the manipulation acceleration component based on the similarity between the speed of the target agent 201 and the weighted average speed. The target action determination unit 120 may determine the manipulation acceleration component with an intention of driving virtually while accelerating more significantly as the similarity between the speed of the target agent 201 and the weighted average speed is lower. The target action determination unit 120 may determine the manipulation steering component with an intention of driving virtually while changing a direction of the virtual driving more significantly as the similarity between the speed of the target agent 201 and the weighted average speed is higher.

Meanwhile, according to an attack of a Random Action method, any real number value may be used as the action of the target agent 201. For example, a section between −1 and 1, which is a section of steering and acceleration that are the actions of the target agent 201, may be divided evenly into 500 points, and two pairs of real numbers randomly selected among them may be used as the target action of the target agent 201, but a section and number of real numbers that may be selected as an arbitrary real number value are not limited thereto.

The target action determination unit 120 may determine one real number randomly selected from preset real numbers as the manipulation steering component. The target action determination unit 120 may determine one real number randomly selected from preset real numbers as the manipulation steering component.

According to the attack methods described above, the attacker using the action poisoning attack system 100 may manipulate to take one of the target actions defined by the methods described above when a preset number (e.g., 4) or more neighboring agents are detected within the LiDAR sensor radius of the target agent 201 randomly selected during the training process of the target model. Adversarial action data is added to the observation of the proximity agents 202 of the target agent 201 by such manipulation, and it may be difficult for the policy of the autonomous driving model 300 to converge to the optimal policy. That is, a road pass rate of the agent 200 in the autonomous vehicle multi-agent reinforcement learning model, which is the target autonomous driving model 300 that is a target when the corresponding attack is performed, may decrease and a rate of collision accident and road departure accident may increase.

At least one component may be added or deleted in response to the performance of the components described above. In addition, it will be easily understood by those skilled in the art that the mutual positions of the components may be changed in response to the performance or structure of the system.

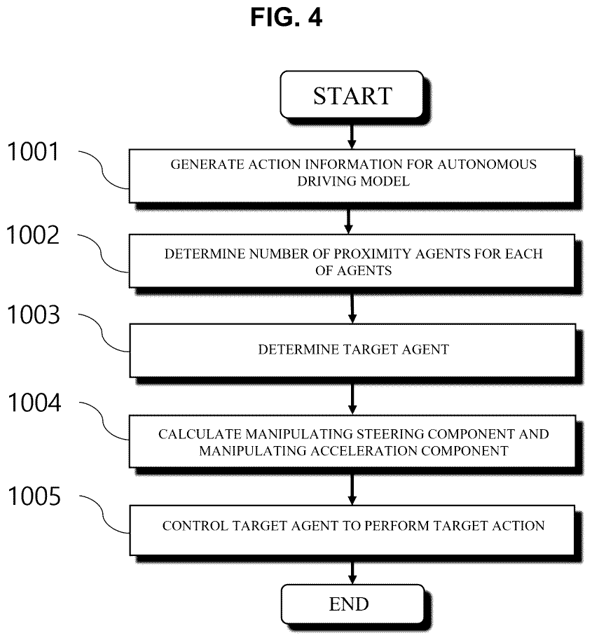

FIG. 4 is a flowchart of an action poisoning attack method according to an embodiment. This is only a preferred embodiment for achieving the purpose of the present invention, and it is obvious that some configurations may be added or deleted as necessary.

Referring to FIG. 4, the autonomous driving model 300 may determine the action information of each agent 200 based on the position and action of other agents 200 in the virtual space (1001).

The target agent determination unit 110 may determine a number of the proximity agents 202 which are other agents 200 positioned within a preset reference distance for each of the agents 200 based on each of the agents 200 (1002).

The target agent determination unit 110 may determine the agent 200 of which the number of the proximity agents 202 is greater than or equal to a preset number as the target agent 201 among the plurality of the agents 200 (1003).

The target action determination unit 120 may change at least one of the steering component and the acceleration component of the action vector output by the autonomous driving model 300 to calculate the manipulation steering component and the manipulation acceleration component, and generate the target action vector including the same as the target action information for the target agent 201 (1004).

The target agent 201 may be controlled to perform the target action, which is an action by the target action information, to interfere with the training of the autonomous driving model 300 (1005).

The target agent determination unit 110 and the target action determination unit 120 may include any one processor among a plurality of processors included in the action poisoning attack system 100. In addition, the action poisoning attack method according to the embodiments of the present invention described so far and the embodiments described later may be implemented in a form of a program that may be driven by the processor.

Here, the program may include a program command, data file, and data structure, etc. alone or in combination. The program may be designed and produced using a machine language code or a high-level language code. The program may be specifically designed to implement the method for the action poisoning attack described above, or may be implemented using various functions or definitions that are known and usable to those skilled in the art in computer software. The program for implementing the action poisoning attack method described above may be recorded in a readable recording medium by the processor. In this case, the recording medium may be a memory.

The memory may store a program that performs the operation described above and an operation described later, and the memory may execute the stored program. In a case where the processor and the memory are provided in plural, they may be integrated into one chip, and may also be provided in physically separated positions. The memory may include a volatile memory such as a Static Random Access Memory (S-RAM) and a Dynamic Random Access Memory (DRAM) for storing data temporarily. In addition, the memory may include a non-volatile memory such as a Read Only Memory (ROM), an Erasable Programmable Read Only Memory (EPROM), and an Electrically Erasable Programmable Read Only Memory (EEPROM) for long-term storage of a control program and control data.

The processor may include various logic circuits and operation circuits, process data according to the program provided from the memory, and generate a control signal according to a processing result.

In order to verify a performance of the action poisoning attack method according to an embodiment of the present invention, an experiment was conducted to perform an attack on a learning process of a continuous control system of the autonomous driving model 300 that is performed in the virtual space.

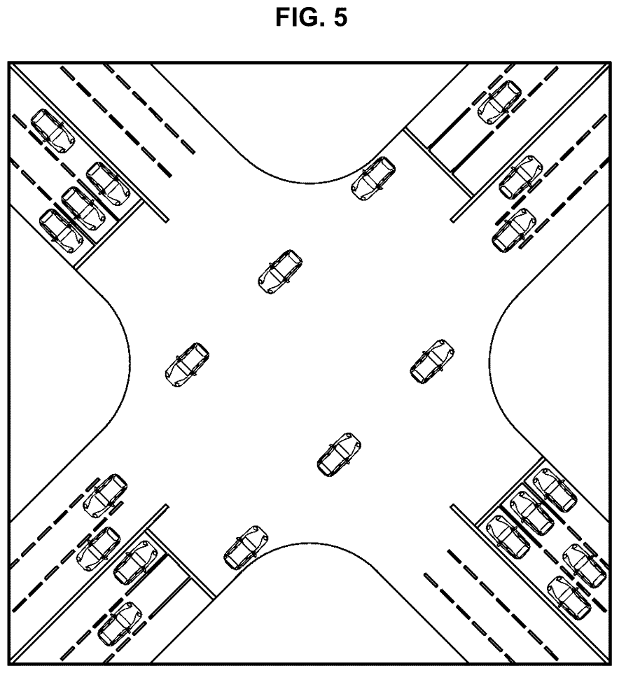

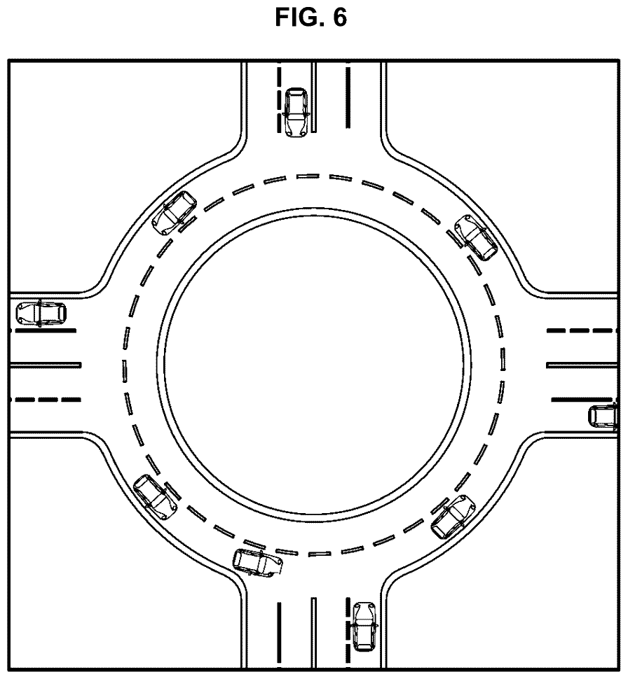

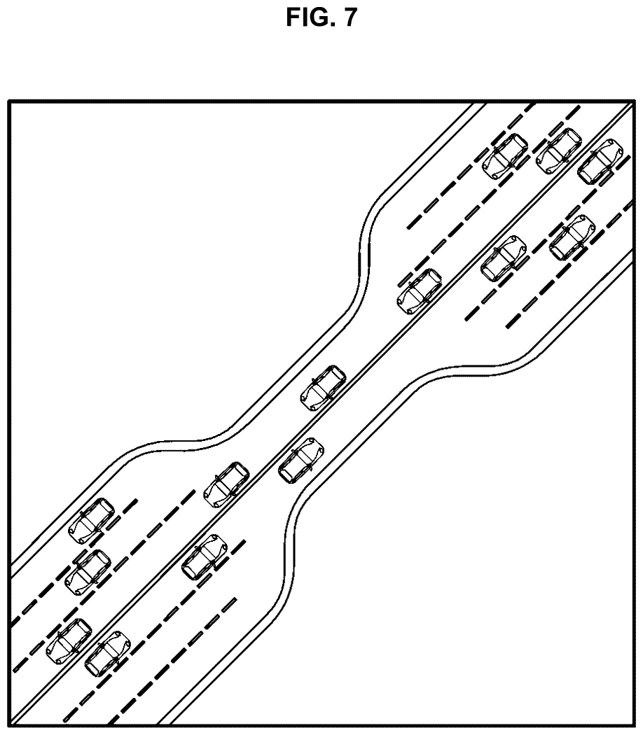

FIG. 5 is a diagram describing an experiment to verify an action poisoning attack method in an intersection map according to an embodiment, FIG. 6 is a diagram describing an experiment to verify an action poisoning attack method in a roundabout map according to an embodiment, and FIG. 7 is a diagram describing an experiment to verify an action poisoning attack method in a bottleneck road map according to an embodiment.

Referring to FIGS. 5, 6 and 7, an experiment was conducted on three victim models based on PPO (Proximal Policy Optimization) for an intersection map, a roundabout map, and a bottleneck road map of the Metadrive simulator. The PPO (Proximal Policy Optimization) may be a model, in which an advantage function is introduced, that applies information about which actions are relatively good or bad to an objective function. In this case, a clipping hyperparameter may be applied to ensure that a policy update is not too abrupt. A Modified Independent PPO (IPPO) is an algorithm that extends the PPO to the MARL and considers only a reward of its own agent, and thus it may be a model that targets an algorithm that modified the objective function to maximize a sum of local rewards. A Mean-Field PPO (MFPO) may be a model in which a Mean-Field MARL is applied and evaluates (centralized Critic) a value of an average state of neighboring agents. A Coordinated PO (CoPO) may be a model that introduces a Local Coordination Factor (LCF) which determines a weight of local rewards/global rewards, trains together to determine an optimal LCF, and reflects a yield as the LCF increases and a selfish behavior (cut in lane) as the LCF decreases. All of the above-described models have things in common that each agent uses information of its neighboring agents during training.

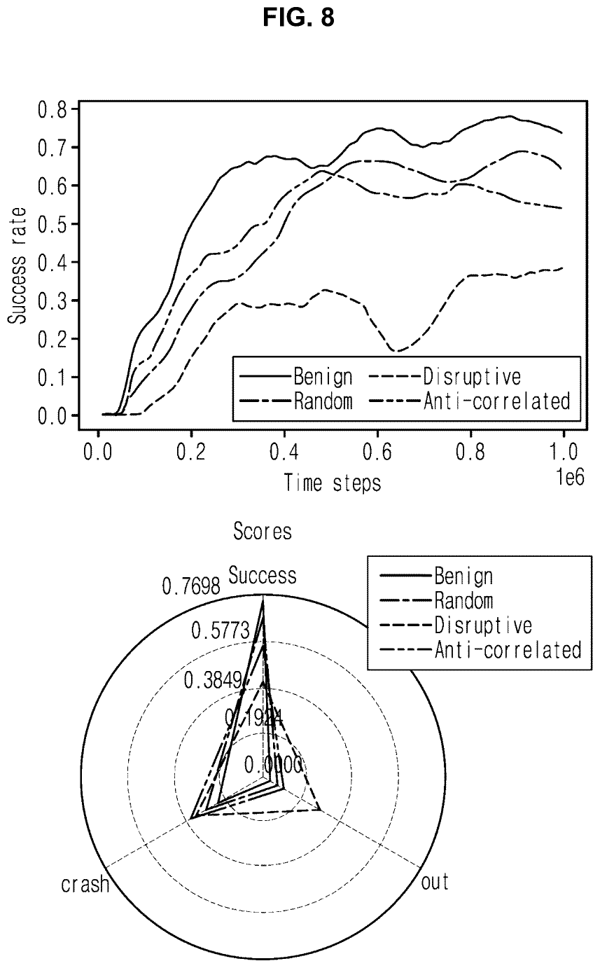

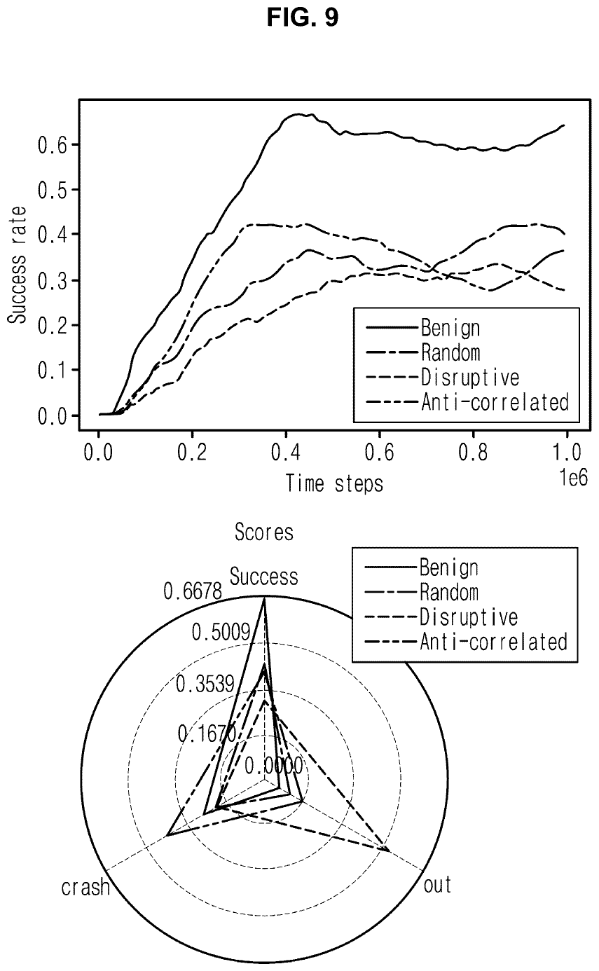

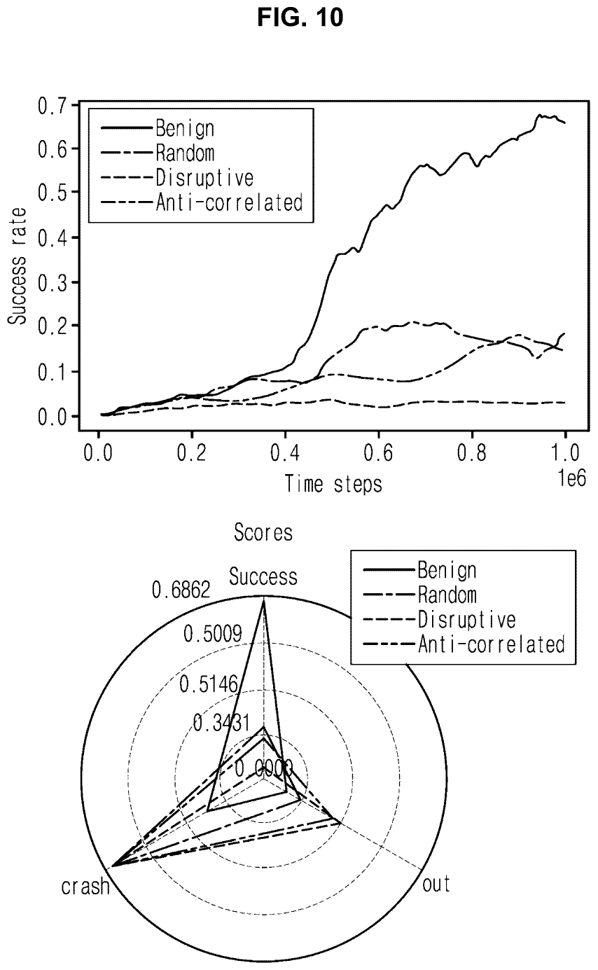

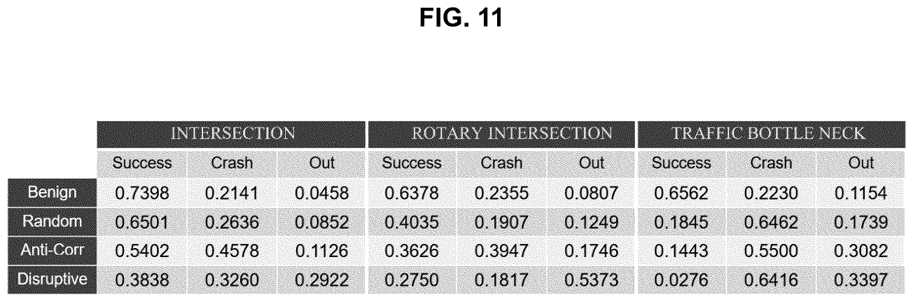

FIG. 8 is a graph for describing a performance of the action poisoning attack method in the intersection map according to an embodiment, FIG. 9 is a graph for describing a performance of the action poisoning attack method in the roundabout map according to an embodiment, FIG. 10 is a graph for describing a performance of the action poisoning attack method in a bottleneck road map according to an embodiment, and FIG. 11 is a table for describing a performance of the action poisoning attack method according to an embodiment.

Referring to FIGS. 8, 9, 10 and 11, a performance of an attack detection method according to an embodiment may be confirmed through an experimental result.

In each experiment, evaluation metrics are a success rate, a crash rate, and an out rate. The success rate is a number of agents that passed a map without going out or crashing divided by a total number of agents. The crash rate is a number of agents destroyed by crashing with other agents divided by the total number of the agents. The out rate is a number of the agents destroyed by going out of a road divided by the total number of the agents.

Referring to FIGS. 8, 9, and 10, success rate graphs for each time step for an intersection, a roundabout, and a bottleneck experiment may be confirmed, respectively. In this case, it may be confirmed that the success rate is significantly lower and a crash rate and an out rate are significantly higher when there are attacks (Anti-correlated, Disruptive, and Random) according to an embodiment compared to the experiment in which the attack is not performed (victim model).

Referring to FIG. 11, it may be confirmed that all three actions, Disruptive, Anti-correlated, and Random, succeeded in attacking, and the bottleneck road was the most vulnerable to the attack and was most affected by the attack compared to the other target models.

As described above, the disclosed embodiments have been described with reference to the following drawings. It will be understood by those skilled in the art to which the present invention pertains that the present invention may be implemented in other forms than the disclosed embodiments without changing the technological scope or essential features of the present invention. The disclosed embodiments are illustrative and should not be construed as purposes of limitation.

1. An action poisoning attack system for an autonomous driving model trained based on an action of each agent determining a movement of each of the agents driving virtually in a virtual space, the action poisoning attack system comprising:
a target agent determination unit configured to determine a target agent that is an attack target intended to perform virtual driving by manipulated action information instead of action information output by the autonomous driving model among a plurality of agents, based on position information of the agents in the virtual space; and
a target action determination unit configured to interfere with training of the autonomous driving model by generating target action information by manipulating the action information output by the autonomous driving model for the target agent and causing the target agent to perform a target action that is an action by the target action information,
wherein the autonomous driving model is
a machine learning model trained through a machine learning method based on the actions of the agents while determining the action information of each agent based on positions and actions of the other agents in the virtual space.

2. The action poisoning attack system of claim 1,
wherein the autonomous driving model is
configured to generate an action vector including a steering component related to steering of each of the agents and an acceleration component related to acceleration/deceleration of each of the agents as the action information for each of the agents, and
the target action determination unit is
configured to generate a target action vector including a manipulation steering component and a manipulation acceleration component by changing at least one of the steering component and the acceleration component of the action vector output by the autonomous driving model.

3. The action poisoning attack system of claim 2,
wherein the target action determination unit is configured to:
generate the target action vector including the manipulation steering component with an intention of driving virtually in a direction completely opposite to a direction in which the target agent has steered based on an action by the action vector output by the autonomous driving model; and
generate the target action vector including the manipulation acceleration component with an intention of driving virtually in the direction completely opposite to the direction at speed at which the target agent has accelerated/decelerated based on the action by the action vector output by the autonomous driving model.

4. The action poisoning attack system of claim 2,
wherein the target agent determination unit is configured to:
determine a number of proximity agents that are other agents positioned within a preset reference distance for each of the agents based on each of the agents; and
determine an agent of which the number of the proximity agents is greater than or equal to a preset number as the target agent among the plurality of agents.

5. The action poisoning attack system of claim 4,
wherein the target action determination unit is configured to:
determine an average value of the steering components of the action vector output by the autonomous driving model for the proximity agents as an average steering component;
determine an average value of the acceleration components of the action vector output by the autonomous driving model for the proximity agents as an average acceleration component;
generate the target action vector including the manipulation steering component with an intention of driving virtually in a direction completely opposite to a direction in which the target agent has steered based on an action of the action vector including the average steering component; and
generate the target action vector including the manipulation acceleration component with an intention of driving virtually in the direction completely opposite to the direction at speed at which the target agent has accelerated/decelerated based on an action of the action vector including the average acceleration component.

6. The action poisoning attack system of claim 4,
wherein the target action determination unit is configured to:
determine a weighted average value of speeds of the proximity agents driving virtually based on the action by the action vector output by the autonomous driving model as a weighted average speed;
determine a similarity between a speed of the target agent driving virtually based on the action by the action vector output by the autonomous driving model and the weighted average speed; and
determine the manipulation acceleration component based on the similarity between the speed of the target agent and the weighted average speed.

7. The action poisoning attack system of claim 6,
wherein the target action determination unit is configured to
determine the manipulation acceleration component with an intention of driving virtually while accelerating more significantly as the similarity between the speed of the target agent and the weighted average speed is lower.

8. The action poisoning attack system of claim 7,
wherein the target action determination unit is configured to
determine the manipulation steering component with an intention of driving virtually while changing a direction of the virtual driving more significantly as the similarity between the speed of the target agent and the weighted average speed is higher.

9. The action poisoning attack system of claim 4,
wherein the target action determination unit is configured to:
determine one real number randomly selected from preset real numbers as the manipulation steering component; and
determine one real number randomly selected from the preset real numbers as the manipulation steering component.

10. As a method of operating an action poisoning attack system for an autonomous driving model trained based on an action of each agent determining a movement of each of the agents driving virtually in a virtual space, a method of controlling the action poisoning attack system comprising:
determining, by a target agent determination unit, a target agent that is an attack target intended to perform virtual driving by manipulated action information instead of action information output by the autonomous driving model among a plurality of agents, based on position information of the agents in the virtual space;
generating, by a target action determination unit, target action information by manipulating the action information output by the autonomous driving model for the target agent; and
interfering, by the target action determination unit, with training of the autonomous driving model by causing the target agent to perform a target action that is an action by the target action information,
wherein the autonomous driving model is a machine learning model configured to be trained through a machine learning method based on the actions of the agents while determining the action information of each agent based on positions and actions of the other agents in the virtual space, and
generate an action vector including a steering component related to steering of each of the agents and an acceleration component related to acceleration/deceleration of each of the agents as the action information for each of the agents,
the determining of the target agent includes:
determining a number of proximity agents that are other agents positioned within a preset reference distance for each of the agents based on each of the agents by the target agent determination unit; and
determining an agent of which the number of the proximity agents is greater than or equal to a preset number as the target agent among the plurality of the agents by the target agent determination unit, and
the generating of the target action information includes
generating a target action vector including a manipulation steering component and a manipulation acceleration component as target action information for the target agent by changing at least one of the steering component and the acceleration component of the action vector output by the autonomous driving model by the target action determination unit.

11. A non-transitory recording medium in which a computer-readable computer program is stored to execute the method of controlling the action poisoning attack system of claim 10.
